(19) United States
(12) Patent Application Publication
(10) Pub. No.: US 2011/0085499 A1
(43) Pub. Date: Apr. 14, 2011

(54) SYSTEM AND METHOD FOR THE SIMULTANEOUS TRANSMISSION AND RECEPTION OF FLO AND FIO-EV DATA

(75) Inventors: KRISHNA K. MUKKAVILLI, San Diego, CA (US); Ralph A. Gholmieh, San Diego, CA (US); Durk L. van Veen, San Diego, CA (US); Raghuraman Krishnamoorthi, San Diego, CA (US); Neville J. Meijers, San Diego, CA (US); Gordon K. Walker, San Diego, CA (US)

(73) Assignee: QUALCOMM Incorporated, San Diego, CA (US)

(21) Appl. No.: 12/876,962

(22) Filed: Sep. 7, 2010

Related U.S. Application Data
(60) Provisional application No. 61/240,949, filed on Sep. 9, 2009.

(51) Int. Cl. H04W 40/00

(52) U.S. Cl. 370/328

(57) ABSTRACT

A system for transmitting a data stream, includes a transmitter for broadcasting a radio frequency communication signal comprising at least one superframe having at least a first data stream encoded therein, and overhead information carried in the superframe, the overhead information comprising a control channel, the control channel having control channel information for separating the at least one first data stream from any other data streams encoded in the at least one superframe. A system for receiving data includes a receiver configured to receive a radio frequency communication signal comprising at least one superframe having at least a first data stream encoded therein; and overhead information carried in the superframe, the overhead information comprising a control channel, the control channel having control channel information for separating the at least one first data stream from any other data streams encoded in the at least one superframe.

### CROSS REFERENCE TO RELATED APPLICATION

This application claims priority to and the benefit of the filing date of U.S. Provisional Application No. 61/240,949, entitled “Method For Transmission Of FLO And FLO-EV Packets in The Same RF Channel” filed on Sep. 9, 2009, the entirety of which is incorporated herein by reference.

### BACKGROUND

The continued development and implementation of wireless communications systems has made it possible to transmit a large amount of data over a radio frequency (RF) air interface. There are a number of technologies that can be used to broadcast video and other programming from a central location to a receiver device. Forward Link Only (FLO) is an example of a transmission methodology that uses a radio frequency (RF) air interface to broadcast video and other programming from one or more central locations to one or more receiver devices. The basic structure of a transmission block in FLO is referred to as a “superframe.” In one implementation, a superframe contains 1200 MAC time units and has a duration of one (1) second. A superframe contains pilot, control and data frames. Typically, four data frames, each containing one or both of wide-area and local-area data are part of a superframe.

The FLO methodology has been improved to increase bandwidth and data carrying capability. The enhanced FLO system is referred to as FLO-EV. The enhanced FLO-EV system introduces additional physical layer transmit modes and allows additional services and capacity to be carried on the FLO network.

As used herein the terms FLO transmitter and FLO receiver refer to transmitters and receivers that are compliant with Revisions 0 and A of TIA-1099. The terms FLO-EV transmitter and FLO-EV receiver refer to transmitters and receivers that are compliant with Revision B of TIA 1099. In particular, a FLO-EV multicast logical channel (MLC) is an MLC that is compliant with Revision B of TIA 1099, but not compliant with earlier releases. A FLO-EV MLC is either a physical layer type 2 (PHY Type 2) MLC that is encoded with a turbo code that spans the bits in the 4 frames of a superframe, or a physical layer type 1 (PHY Type 1) MLC that is encoded similarly to Rev A of TIA-1099 but that has a different trailer and OIS (overhead information symbol) location record structure to allow a larger peak rate on the MLC.

The physical layer coding structure of FLO-EV is different from that of FLO, thereby introducing challenges when attempting to use a single radio frequency (RF) channel for both FLO and FLO-EV data. Existing devices that are FLO capable, are unable to decode a FLO-EV signal.

For backward compatibility purposes, it is desirable to allow both FLO and FLO-EV data to be carried on the same radio frequency (RF) channel and be received by existing FLO capable devices, and by new FLO and FLO-EV capable devices without error.

### SUMMARY

Embodiments of the invention include a system for transmitting a data stream, comprising a transmitter for broadcasting a radio frequency communication signal comprising at least one superframe, the at least one superframe having at least a first data stream encoded therein, and overhead information carried in the superframe, the overhead information comprising a control channel, the control channel having control channel information for separating the at least one first data stream from any other data streams encoded in the at least one superframe.

In another embodiment, a system for receiving data comprises a receiver configured to receive a radio frequency communication signal comprising at least one superframe, the at least one superframe having at least a first data stream encoded therein; and overhead information carried in the superframe, the overhead information comprising a control channel, the control channel having control channel information for separating the at least one first data stream from any other data streams encoded in the at least one superframe.

Other embodiments are also provided. Other systems, methods, features, and advantages of the invention will be or become apparent to one with skill in the art upon examination of the following figures and detailed description. It is intended that all such additional systems, methods, features, and advantages be included within this description, be within the scope of the invention, and be protected by the accompanying claims.

### BRIEF DESCRIPTION OF THE FIGURES

The invention can be better understood with reference to the following figures. The components within the figures are not necessarily to scale, emphasis instead being placed upon clearly illustrating the principles of the invention. Moreover, in the figures, like reference numerals designate corresponding parts throughout the different views.

FIG. 1 is a block diagram illustrating the basic elements of a forward link only (FLO) network.

FIG. 2 is a block diagram illustrating a portion of a receiver of the portable communication device of FIG. 1.

FIG. 3 is a block diagram illustrating an example of a superframe suitable for carrying FLO and FLO-EV data.

FIG. 4 is a graphical illustration showing a frame portion containing example multicast logical channels.

FIG. 5 is a diagram illustrating the system parameters message (SystemParameters Message) carried in the wide area OIS (or local-area OIS) of FIG. 3.

FIGS. 6A through 6D are diagrams illustrating various additional fields of the SystemParameters Message of FIG. 5 as they relate to an MLC Records Table.

FIGS. 6E through 6H are diagrams illustrating various additional fields of the SystemParameters Message of FIG. 5 as they relate to an extended MLC Records Table.

FIG. 7 is a block diagram illustrating the relationship among an MLC, the OIS, and the control channel (CC).

FIG. 8 is a flowchart describing an exemplary power up sequence of a portable communication device of FIG. 1.

FIG. 9 is a flowchart describing flow acquisition in a portable communication device of FIG. 1.

### DETAILED DESCRIPTION

The system and method for the simultaneous transmission and reception of FLO and FLO-EV data will be described in the context of a receiver in a portable communication device having the ability to receive and discriminate between multiple data streams on a single radio frequency (RF) channel.

The system and method for the simultaneous transmission and reception of FLO and FLO-EV data can be implemented in hardware, software, or a combination of hardware and software. When implemented in hardware, the system and method for the simultaneous transmission and reception of FLO and FLO-EV data can be implemented using specialized hardware elements and logic. When portions of the system and method for the simultaneous transmission and reception of FLO and FLO-EV data are implemented in software, the software can be used to control the various components in a receiver of a portable communication device.

The software can be stored in a memory and executed by a suitable instruction execution system (microprocessor). The hardware portion of the system and method for the simultaneous transmission and reception of FLO and FLO-EV data can include any or a combination of the following technologies, which are all well known in the art: discrete electronic components, a discrete logic circuit(s) having logic gates for implementing logic functions upon data signals, an application specific integrated circuit having appropriate logic gates, a programmable gate array(s) (PGA), a field programmable gate array (FPGA), etc.

The software for the system and method for the simultaneous transmission and reception of FLO and FLO-EV data comprises an ordered listing of executable instructions for implementing logical functions, and can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM), a read-only memory (ROM), an erasable programmable read-only memory (EPROM or Flash memory) (magnetic), an optical fiber (optical), and a portable compact disc read-only memory (CDROM) (optical). Note that the computer-readable medium could even be paper or another suitable medium upon which the program is printed, as the program can be electronically captured, via for instance, optical scanning of the paper or other medium, then compiled, interpreted or otherwise processed in a suitable manner if necessary, and then stored in a computer memory.

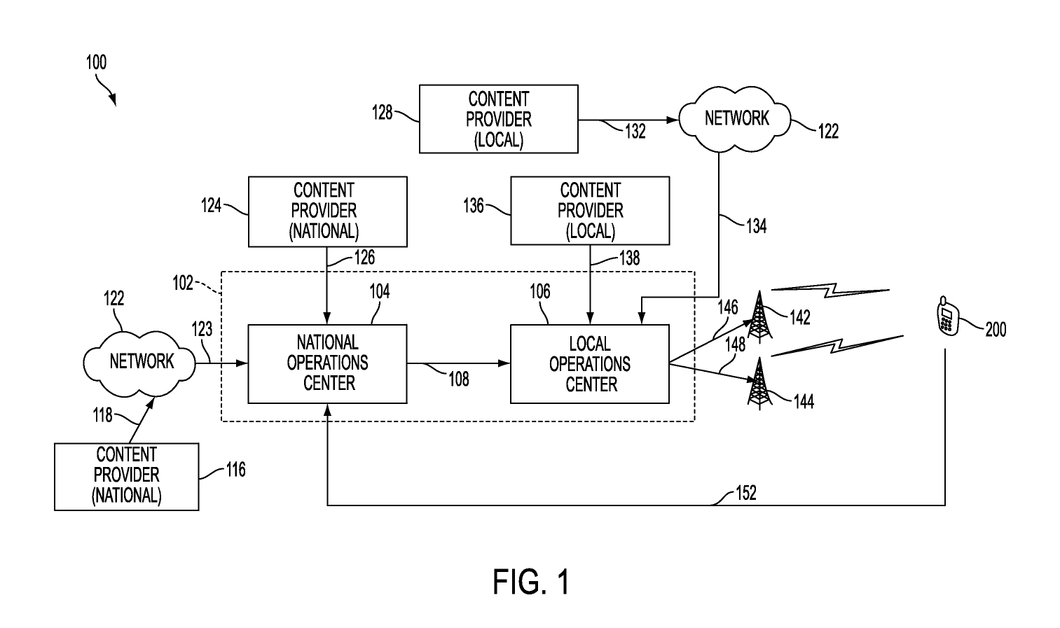

FIG. 1 is a block diagram illustrating the basic elements of a forward link only (FLO) network. The flow network 100 comprises a network operations center 102 one or more flow transmitters 142, 144, a reverse link 152 and one or more portable communication devices 200. In an embodiment, the network operations center 102 comprises a national operations center 104 and a local operations center 106. The national operations center 104 provides a national multiplex distribution stream over connection 108 to the local operations center 106. The connection 108 can be any high capacity communications channel.

The network operations center 102 receives content from a number of different sources over a number of different paths. Content may include, but is not limited to, data, audio, video, television programming, or other content. For example, the national operations center 104 can receive national content from a content provider 124 directly over a connection 126. The connection 126 can be a direct physical connection, a wireless connection or any other connection over which content can be provided to the national operations center 104. Alternatively, the national operations center 104 can receive national content from a content provider 116 over a network 122. The network 122 can be any of a wide area, a local area, or any other communications network over which content can be received over connection 118 from the content provider 116 and provided over connection 123 to the national operations center 104.

Similarly, the local operations center 106 can receive local content directly from a content provider 136 over connection 138. The connection 138 can be similar to the connection 126. Alternatively, the local operations center 106 can receive local content from a content provider 128 over the network 122 via connection 134. National content is content that can be provided to all portable communication devices 200, while local content is content that can be provided to a subset of all portable communication devices based on geographical location.

The network operations center provides the content to a wireless broadcast network embodied by transmitters 142 and 144. The transmitters 142 and 144 are intended to illustrate the entire infrastructure used to receive a terrestrial-based communication signal over connections 146 and 148, and to provide a wireless mobile broadcast transmission to the portable communication device 200. While the details of the FLO network are known to those having ordinary skill in the art, it should be mentioned that the FLO network is a diversity-type network in which multiple transmitters (e.g., transmitters 142 and 144) are used to send multiple signals having identical content from a number of transmitters to each portable device 200. The portable communication device 200 comprises any mobile or portable communication device, such as, for example, a cell phone, a personal digital assistant (PDA), a wireless television receiver, or any other portable communication device. The portable communication device 200 includes a receiver configured to receive the FLO transmission from the transmitters 142 and 144.

The portable communication device 200 is also coupled to the national operations center 104 via a reverse link 152. In an embodiment, the reverse link 152 can be a 3G, or a 4G wireless communication channel provided by a cellular communication carrier or provider. The reverse link 152 allows the portable communication device 200 to submit registration and authentication information to the national operations center 104 so that the portable communication device 200 receives the appropriate content. However, it should be mentioned that the transmission of content from the network operations center, via the flow transmitters 142 and 144, to the portable communication device 200 are one way only.

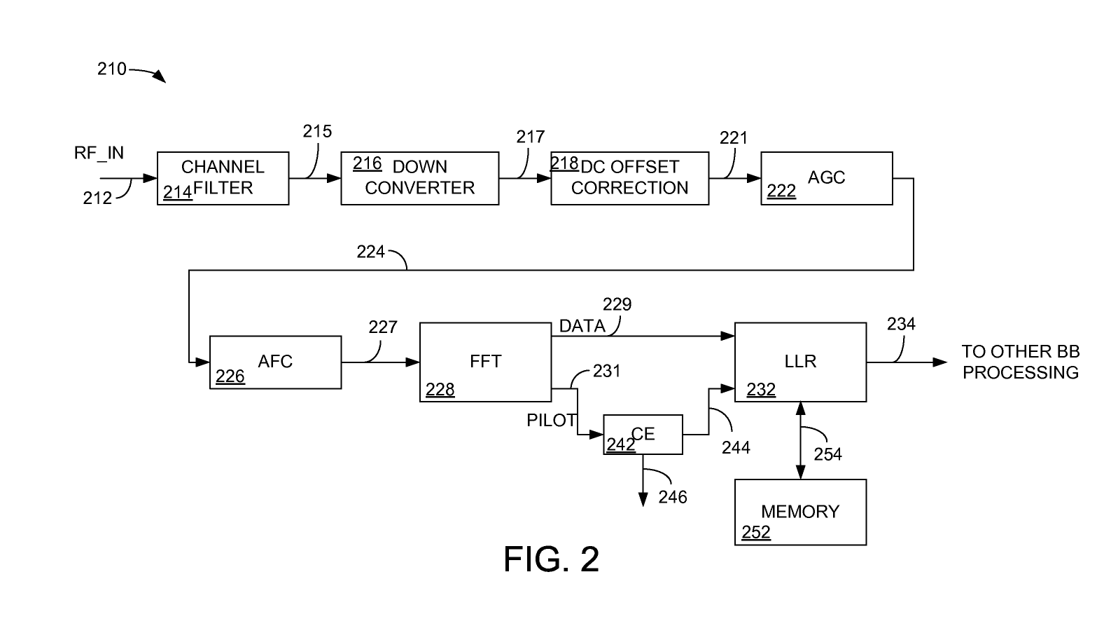

FIG. 2 is a block diagram illustrating a portion of a receiver of the portable communication device 200 of FIG. 1. The receiver portion 210 shown in FIG. 2 illustrates only the basic components of a receiver within the portable communication device 200. Details of a receiver are known to those having ordinary skill in the art. The receiver portion 210 receives a radio frequency (RF) signal over connection 212. The received RF signal is provided to a channel filter 212, which filters the received RF signal to develop a signal on connection 215 at the desired receive frequency. The RF signal on connection 215 is an analog signal that has undergone initial receiver processing, which may also include one or more of switching, low noise amplification or other front end receiver processing to prepare the RF signal for decoding.

The signal on connection 215 is provided to a downconverter 216. The downconverter 216 translates the signal on connection 215 from an RF signal to either an intermediate frequency (IF) or to baseband, or near-baseband if the receiver is implemented as a direct conversion receiver.

The signal on connection 217 is provided to a DC offset correction element 218, which corrects for any DC offset imparted to the signal in connection 217. The output of the DC offset correction element 218 is provided over connection 221 to an automatic gain control (AGC) element 222. The AGC element 222 adjusts the gain of the signal on connection 221 and provides a gain adjusted signal on connection 224. The AGC element 222 may comprises one or more analog and/or digital gain stages and can also convert the analog signal on connection 221 to a digital signal on connection 224.

The output on connection 224 is provided to an automatic frequency control (AFC) element 226. The AFC element 226 stabilizes the frequency of the signal on connection 224 and provides an output over connection 227 to the FFT element 228. The FFT element 228 provides a data output over connection 229 and provides a pilot symbol output over connection 231.

The data output of the FFT element 228 on connection 229 is provided to a log likelihood ratio (LLR) generator 232, which performs signal processing, and provides the data output to a turbo decoding element (not shown), and other processing elements over connection 234. The pilot symbol signal provided on connection 231 is provided to a channel estimate (CE) element 242. The CE element 242 provides the pilot symbol over connection 244 to the LLR generator 232 and also provides an estimate of the channel energy for each symbol over connection 246. A memory 252 is coupled to the LLR generator 232 over connection 254. The memory can be used to store the information on connections 229 and 244, and can be used to store the software for the system and method for the simultaneous transmission and reception of FLO and FLO-EV data.

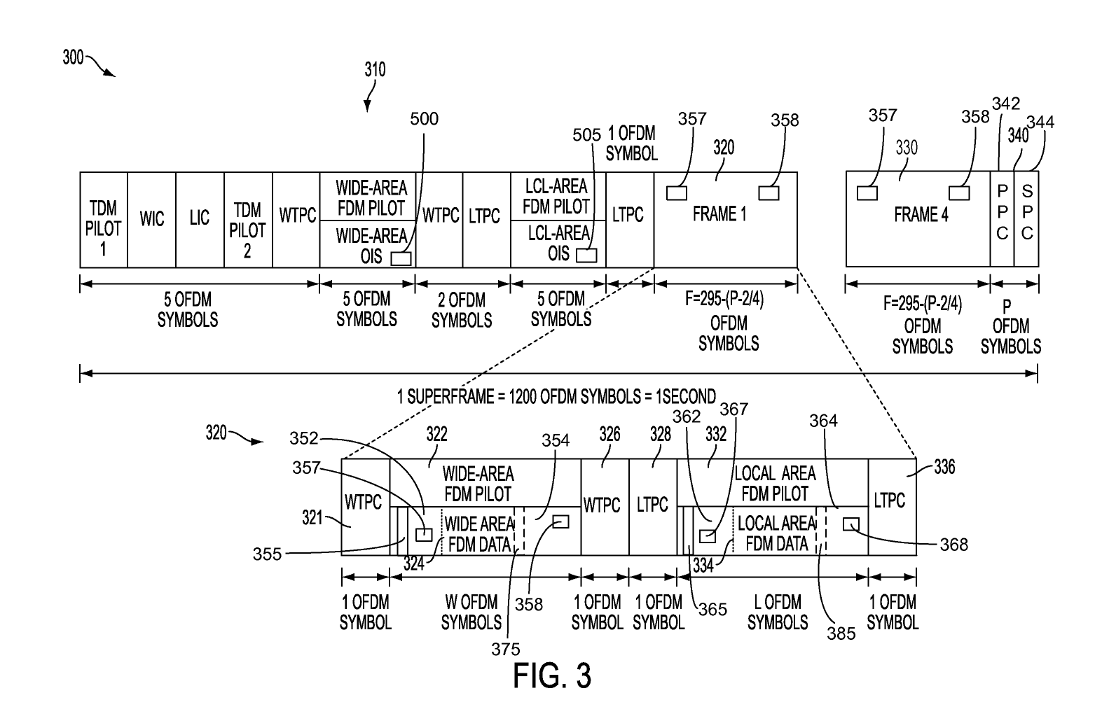

FIG. 3 is a block diagram illustrating an example of a superframe 300 suitable for carrying FLO and FLO-EV data. In an embodiment, the superframe 300 can be assembled by the network operations center 102 (FIG. 1) for transmission to the portable communication device 200 (FIG. 1). The superframe 300 comprises a preamble portion 310 that comprises pilot and OIS (overhead information symbol) information, frames 320 and 330, and portion 340, which includes positional pilot channel 342 and signaling parameter channel 344 Although four (4) frames are included in a superframe 300, only frames one (1) and four (4) are shown in FIG. 3 for simplicity of illustration.

The preamble 310 comprises 18 OFDM symbols in which TDM pilot channels occupy the first four symbols and a wide area transition pilot channel (WTPC) occupies the fifth symbol. The next five symbols are divided among wide area FDM pilot and wide area OIS information. The wide area OIS information portion includes a system parameters message 500, which will be described in greater detail below. The following two symbols comprise wide area transition pilot channel (WTPC) information and local area transition pilot channel (LTPC) information, while the following five symbols are divided between local area FDM pilot information and local area OIS information. The local area OIS information portion also includes a system parameters message 505, similar to the systems parameter message 500, for local OIS information. The following symbol comprises a local area transition pilot channel (LTPC).

Frames one through four are similar in structure so only frame one, 320, will be described in detail. Frame one, 320, comprises a wide area transition pilot channel (WTPC) 321 occupying a first symbol, “W” symbols comprising wide area FDM pilot information 322 and wide area FDM data 324, a single OFDM symbol comprising WTPC information 326, a single OFDM symbol comprising LTPC information 328, “L” OFDM symbols comprising local area FDM pilot information 322 and local area FDM data 334, followed by a single OFDM symbol 336 comprising the LTPC.

The superframe 300 can comprise both wide area and local area data, depending on system application. Further, in an embodiment, the superframe 300 can comprise data streams having both FLO and FLO-EV data. A FLO-EV multicast logical channel (MLC) is an MLC that is compliant with Revision B of TIA 1099, but not compliant with earlier releases. A FLO-EV MLC is either a physical layer type 2 (PHY Type 2) MLC that is encoded with a turbo code that spans the bits in the 4 frames of a superframe, or a physical layer type 1 (PHY Type 1) MLC that is encoded similarly to Rev A of TIA-1099 but that has a different trailer and OIS (overhead information symbol) location record structure to allow a larger peak rate on the MLC. A device capable of receiving PHY type 1 is able to decode transmit modes specific to PHY Type 1 transport. Similarly, a device capable of receiving PHY type 2 is able to decode transmit modes specific to PHY Type 2 transport. A PHY Type 1 transmit mode carries the data in what is referred to as a PHY Type 1 multicast logical channel (MLC) and a PHY Type 2 transmit mode carries the data in a PHY type 2 mLC. The term “transmit mode” refers to the transmit scheme used to send information from the transmitters 142, 144, to the portable communication device 200 (FIG. 1).

A PHY Type 1 transmit mode may be used to send the superframe 300 containing FLO data to a portable communication device 200; a PHY Type 2 transmit mode may be used to send the superframe 300 containing FLO-EV data to a portable communication device 200; and PHY Type 1 and PHY Type 2 transmit modes may be used to send the superframe 300 containing FLO data and FLO-EV data to a portable communication device 200. Further, in an embodiment, FLO data and FLO-EV data can be transported in the same superframe or in different superframes. In another embodiment, only FLO data is transported in a superframe, and in another embodiment only FLO-EV data is sent in a superframe.

A portable communication device 200 can be implemented in a variety of ways to receive any or all of FLO and FLO-EV data in either or both of a PHY Type 1 transmit mode or a PHY Type 2 transmit mode, whether in the same superframe or in different superframes. In an embodiment, and for example purposes only, the portable communication device 200 can be considered a class 1 device that can receive and decode FLO data; a class 2 device that can receive and decode FLO-EV data; a class 3 device that can receive and decode FLO data and FLO-EV data in separate superframes, i.e., the device can either decode the FLO data being broadcast or the FLO-EV data being broadcast, but not both, in one superframe; and a class 4 device that can receive and decode FLO data and FLO-EV data in the same superframe.

In an embodiment in which the superframe 300 comprises both FLO and FLO-EV data, the wide area FDM data portion 324 comprises a wide area FLO data portion 352 and a wide area FLO-EV data portion 354. Similarly, in an embodiment in which the superframe 300 comprises both FLO and FLO-EV data, the local area FDM data portion 334 comprises a local area FLO data portion 362 and a local area FLO-EV data portion 364. Further, in an embodiment, there is no restriction on the location of FLO (PHY Type 1 device and MLC) and FLO-EV (PHY Type 2 device and MLC) and either or both of PHY Type 1 transmit modes and PHY Type 2 transmit modes. Corresponding MLCs may be carried anywhere within the wide area FDM data portion 324. Similarly, either or both of PHY Type 1 transmit modes and PHY Type 2 transmit modes, and corresponding MLCs, may be carried anywhere within the local area FDM data portion 334.

The wide area FDM data portion 324 comprises a control channel (CC) MLC 355, and for example purposes only, comprises a FLO MLC 357 and a FLO-EV MLC 358. Similarly, the local area FDM data portion 334 comprises a control channel (CC) MLC 365, and for example purposes only, comprises a FLO MLC 367 and a FLO-EV MLC 368.

In addition, the wide area FLO-EV data portion 354 may optionally include a wide area FLO-EV CC MLC 375; and the local area FLO-EV data portion 364 may optionally include a local area FLO-EV CC MLC 385. The inclusion of a wide area FLO-EV CC MLC 375 and a local area FLO-EV CC MLC 385 allows a control channel to be sent in a network that includes both PHY Type 1 devices and PHY Type 2 devices, and in a network that includes only PHY Type 2 devices. Furthermore, this embodiment would be compatible with the first 3 classes of devices mentioned above, since a device would always be able to decode updates to the control channel to enable continued reception of data flows.

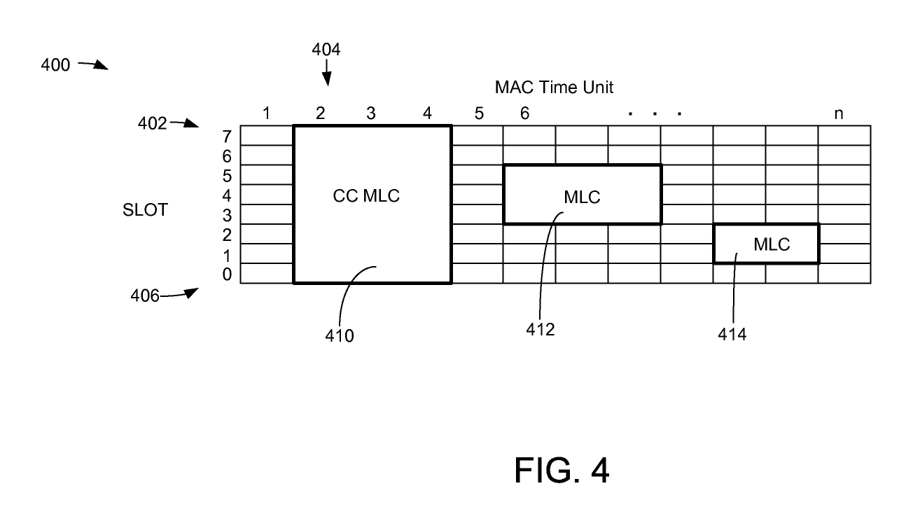

FIG. 4 is a graphical illustration 400 showing a frame portion 402 containing example multicast logical channels. The frame portion 402 can be part of either the wide area FDM data portion 324 (FIG. 3) or the local area FDM data portion 334 (FIG. 3). The frame portion 402 comprises a number (“W” or “L” of FIG. 3, depending on whether the subject frame contains wide area or a local area data) of symbols that can occur, for example, within the data portion 324 or 334 of the frame 320 of FIG. 3. The frame portion 402 contains a number of MAC time units 404, which are each further subdivided into eight (8) slots 406. In general, one MAC time unit is either ½ (if FFT=8K), 1 (if FFT=4K), 2 (if FFT=2K) or 4 (if FFT=1 K) OFDM symbols. A MAC time unit may be spread over multiple OFDM symbols. Each MLC is mapped to MAC time units.

For example purposes only, a control channel (CC) multicast logical channel (MLC) 410 is shown as spanning MAC time units 2, 3 and 4, and occurs within all of the slots 406.

For example purposes only, a first multicast logical channel (MLC) 412 is shown as spanning MAC time units 6, 7 and 8, and as occurring within slots 3-5. A second exemplary MLC 414 is shown as spanning MAC time unit n-2 and n-1, and occurs within slots 1 and 2.

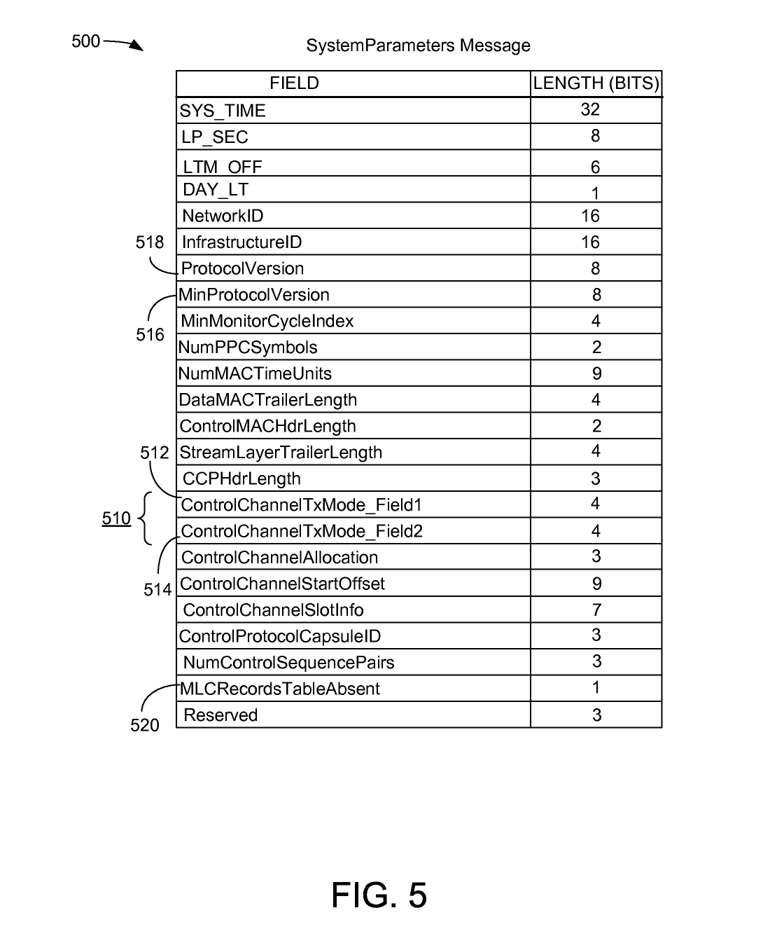

FIG. 5 is a diagram illustrating the system parameters message (SystemParameters Message) 500 carried in the wide area OIS (and 505 when carried in the local-area OIS) of FIG. 3. The SystemParameters Message comprises a number of information fields that define FLO and FLO-EV data carried by PHY Type 1 and PHY Type 2 transmit modes, depending on the application. As an example, to support the availability of both FLO and FLO-EV data, the fields 510 are modified from that used in deployments with only PHY Type 1 transmit mode to accommodate a PHY Type 2 transmit mode as well. Previously, when carrying only PHY Type 1 MLCs, the field 512 referred to the transmit mode (modes 0 to 11, where modes 12 to 15 are unused), and the field 514 was the Reed-Solomon (RS) outer-code mode (0000=no outer code, 1=14/16, 2=12/16, 3=8/16). This arrangement still applies if the subject MLC is PHY Type 1. If the subject MLC is a PHY Type 2 mLC, then the field 514 contains the 4 most significant bits of the 8 bit PHY Type 2 transmit mode, and the field 512 contains the 4 least significant bits of the 8 bit PHY Type 2 transmit mode. The following values of {field2} {field1} (field 514/field 512) are in use: {0000} {0000-1011} (i.e. values 0 to 11 indicating PHY Type 1 modes 0 to 11 with no outer code), {0001} {0000-1011} (i.e. values 16 to 27 indicating PHY Type 1 modes 0 to 11 with RS(14,16) outer code), {0010} {0000-1011} (i.e. values 32 to 43 indicating PHY Type 1 modes 0 to 11 with RS(12,16) outer code), {0011} {0000-1011} (i.e. values 48 to 59 indicating PHY Type 1 modes 0 to 11 with RS(8,16) outer code). This is the reason that PHY Type 2 transmit modes start at 64. It is possible to have filled the numerical gaps and used modes 12, 13, 14, 15, 28, 29, etc., but such would be less practical from a usability point of view. Therefore, possible combinations include FLO=>PHY Type 1 transmit modes, and new combinations for the two fields=>8 bit transmit mode numbers (PHY Type 2 modes are 64 to 72, and 80 to 91).

The field 512 comprises four (4) available bits for ControlChannelTXMode_Field1 information and the field 514 comprises four (4) available bits for ControlChannelTXMode_Field2 information. By including the fields 512 and 514, the SystemParameters Message 500 can signal to the receiver 210 within the portable communication device 200, a specific transmit mode that can support FLO and/or FLO-EV data. For example, the fields 512 and 514 can be used to carry information relating to a physical type 1 transmit mode that carries a first type MLC (PHY Type 1 mLC), or the fields 512 and 514 can be used to carry information relating to a physical type 2 transmit mode that carries a second type MLC (PHY type 2 mLC). A PHY Type 1 mLC and a PHY Type 2 mLC can be carried on the same RF channel as the FLO data. In still another embodiment, a new field could be added to signal the presence of a second control channel with the understanding that the two control channels would carry the same data, but that one control channel would use a PHY Type 1 transmit mode for FLO devices, and that the second control channel would use a PHY type 2 transmit mode for a) greater coverage, and/or b) ability of devices decoding PHY Type 2 MLCs to simultaneously decode the control channel without requiring the receiver to be able to decode PHY Type 1 and PHY type 2 MLCs simultaneously.

The SystemParametersMessage 500 also includes a minimum protocol version (MinProtocolVersion) field 516 and a Protocol Version field 518. The field 516 is used to signal the minimum protocol version specified for the portable communication device 200 to receive a particular flow. For example, when the control channel MLC is sent using a transmit mode associated with FLO data (PHY Type 1) the MinProtocolVersion field 516 can be set to a logic “0” indicating that all devices can decode and interpret the OIS and the control channel. When the control channel MLC is sent using a transmit mode associated with FLO-EV data (PHY Type 2) the MinProtocolVersion field 516 can be set to a logic “2” indicating that PHY Type 1 devices cannot decode and interpret the OIS and the control channel.

The SystemParametersMessage 500 also includes a protocol version (ProtocolVersion) field 518. The field 518 is used to signal the current version of the Forward Link Only system protocol supported by the infrastructure. For example, in deployments where OIS and control channel are signaled using a PHY Type 1 transmit mode, and the data MLCs are sent using both PHY Type 1 and PHY Type 2 transmit modes, field 516 of the SystemParametersMessage 500 may be set to “0” and field 518 may be set to “2”.

The field 520, referred to as MLCRecordsTableAbsent, comprises a length of one bit, and is used to inform the receiver 210 whether the superframe 300 carries an MLC records table.

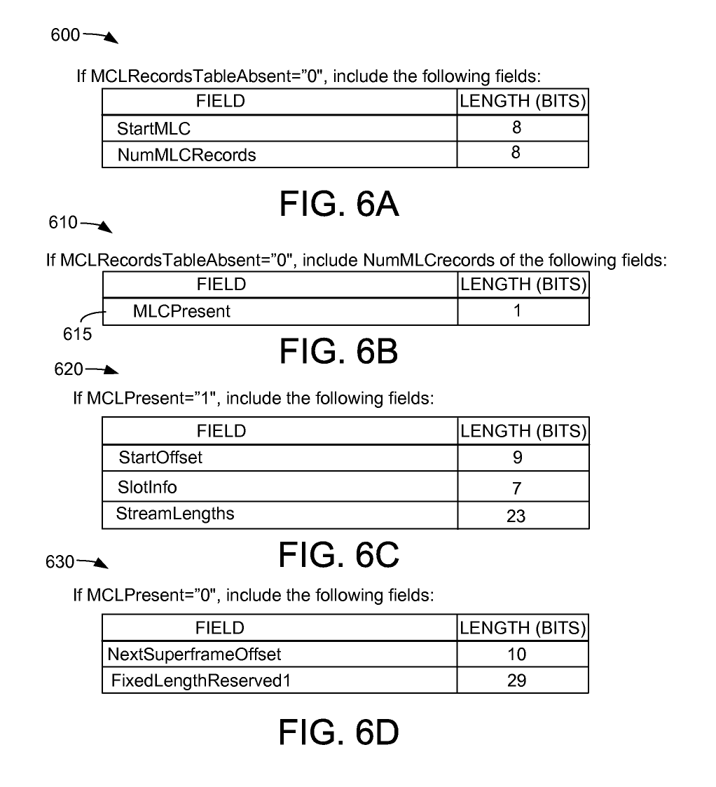

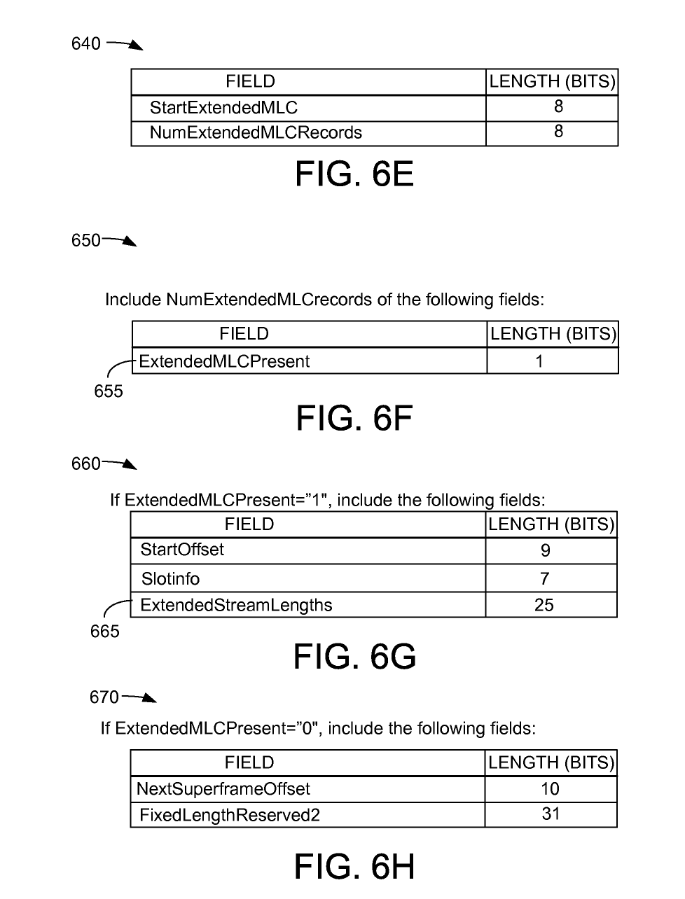

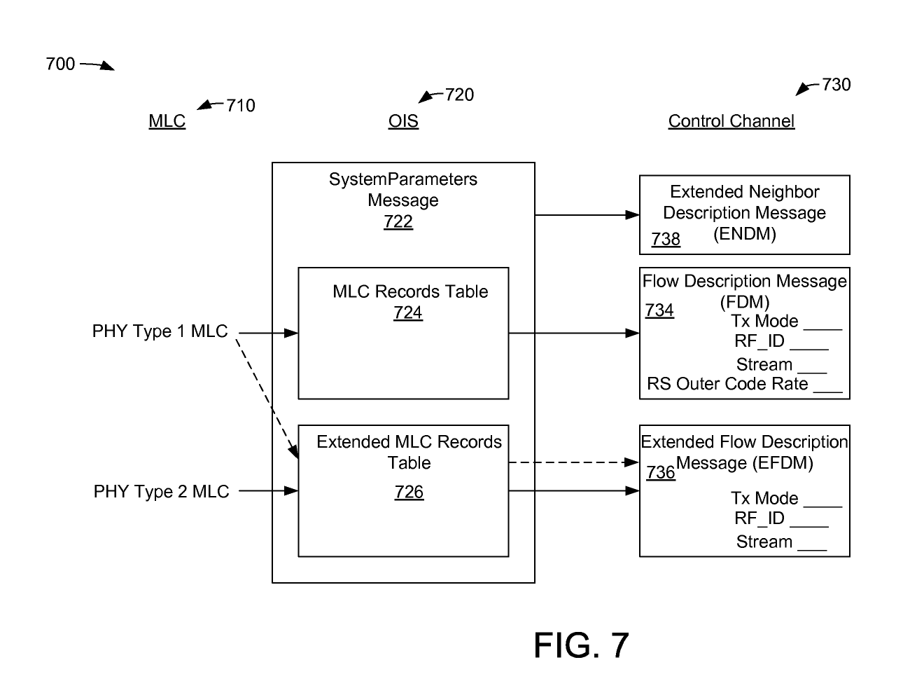

FIGS. 6A through 6D are diagrams illustrating various additional fields of the SystemParameters Message 500 of FIG. 5 as they relate to an MLC Records Table. In an embodiment, the additional fields can be added to an MLC in what is referred to as a “MAC trailer.” The diagram 600 illustrates a case where if the MLCRecordsTableAbsent field 520 (FIG. 5) is equal to logic “0”, then a StartMLC field having a length of eight (8) bits and a NumMLCRecords field having a length of eight (8) bits are included. When backward compatibility from a PHY Type 2 device to a PHY Type 1 device is desired, the StartMLC field, the NumMLCRecords field, and an MLC Records Table (FIG. 7) should always be present, and the MLCRecordsTableAbsent field 520 should be set to “0”. This bit may be set by the infrastructure in deployments with the minimum protocol version (field 516) set to “2”.

FIG. 6B shows a diagram 610 illustrating a case where if the MLCRecordsTableAbsent field 520 is equal to a logic “0”, then the NumMLCRecords of the field 615 (MLCPresent) is included. The field 615 has a length of one bit.

FIG. 6C shows a diagram 620 illustrating a case where if the MLCPresent field 615 (FIG. 6B) is equal to logic “1”, then the following fields are included: StartOffset, having a length of nine (9) bits; SlotInfo, having a length of seven (7) bits; and StreamLengths, having a length of 23 bits.

FIG. 6D shows a diagram 630 illustrating a case where if the MLCPresent field 615 (FIG. 6B) is equal to logic “0”, then the following fields are included; NextSuperframeOffset, having a length of 10 bits; and FixedLengthReserved1, having a length of 29 bits.

FIGS. 6E through 6H are diagrams illustrating various additional fields of the SystemParameters Message 500 of FIG. 5 as they relate to an extended MLC Records Table.

FIG. 6E shows a diagram 640 illustrating an extended MLC Records Table header including the following fields. StartExtendedMLC, having a length of eight (8) bits; and NumextendedMLCrecords, having a length of eight (8) bits.

FIG. 6F shows a diagram 650 illustrating a case where the NumExtendedMLCRecords of the following fields are included: ExtendedMLCPresent field 655, having a length of one (1) bit.

FIG. 6G shows a diagram 660 illustrating a case where if the ExtendedMLCPresent field 655 in FIG. 6F is equal to logic “1”, then the following fields are included: StartOffset, having a length of nine (9) bits; SlotInfo, having a length of seven (7) bits; and ExtendedStreamLengths, having a length of 25 bits. The ExtendedStreamLengths field 665 is made 2 bits longer than the StreamLengths field of FIG. 6C to allow a maximum number of packets on a larger stream that is 4 times greater than in the StreamLengths field. Further, the ExtendedStreamLengths field could be even longer (with no loss of generality) to increase the peak rate on medium and small streams as well.

FIG. 6H shows a diagram 670 illustrating a case where if the ExtendedMLCPresent field 655 in FIG. 6F is equal to logic “0”, then the following fields are included: NextSuperframeOffset, having a length of 10 bits; and FixedLengthReserved, having a length of 31 bits.

FIG. 7 is a block diagram 700 illustrating the relationship between an MLC, the OIS, and the control channel (CC). An MLC is generally shown using reference 710, the OIS is generally shown using reference 720 and the control channel is generally shown using reference 730.

In this example, the MLC 710 can be one of a physical type 1 mLC (PHY Type 1 mLC) or a physical type 2 mLC (PHY Type 2 mLC). In an embodiment, a portable communication device 200 that is capable of receiving a FLO transmission is only capable of decoding PHY Type 1 MLCs encoded using the protocols defined in Rev. 0 and A of TIA-1099. A portable communication device 200 that is capable of receiving a FLO-EV transmission is capable of decoding PHY Type 2 MLCs encoded using the protocols defined in Rev. B of TIA-1099. Further, it is possible that a single portable communication device 200 can be capable of receiving and decoding both a PHY Type 1 mLC and a PHY Type 2 mLC. Further still, it is possible that a single portable communication device 200 can be capable of receiving and decoding only a PHY Type 1 mLC, in which case all PHY Type 2 MLCs should be ignored. Moreover, it is possible that a single portable communication device 200 can be capable of receiving and decoding both a PHY Type 1 mLC and a PHY Type 2 mLC but not within the same superframe. Further, it is possible that a single portable communication device 200 can be capable of receiving and decoding a PHY Type 1 mLC, associated with a longer stream length (and thus higher peak rate), thus using the new trailer structure and the extended location table structure in OIS as defined in TIA 1099 Rev. B.

The OIS 720 is shown as including SystemParameters Message 722. The SystemParameters Message 722 is similar to the SystemParameters Message 500 described above. However, the SystemParameters Message 722 is illustrated in FIG. 7 as including an MLC Records Table 724 and an Extended MLC Records Table 726.

The MLC Records Table 724 includes the MLC location information of all flows listed in the Flow Description Message (FDM) 734. Similarly, the Extended MLC Records Table 726 includes the MLC location information of all flows listed in the Extended Flow description Message (EFDM) 736. If only PHY Type 2 flows are broadcast, then all MLC location information will be carried in the EFDM 736. The FDM 734 and the EFDM 736 also include information, such as for example, Tx_Mode, RF_ID, Stream number, RS Outer Code Rate (if applicable for PHY Type 1 transmit mode), and other attributes of the respective data stream identified in the FDM 734 and/or EFDM 736.

The FDM 734 includes the flow description of all flows that are assigned to MLCs with transmit modes 0 through 4 and 6 through 11 and whose MLC locations are listed in the MLC Records Table 724. Similarly, the EFDM 736 includes the flow description of all flows that are assigned to MLCs with transmit modes 0 through 4 and 6 through 11 and whose MLC locations are listed in the Extended MLC Records Table 726; and includes the flow description of all flows that are assigned to MLCs with transmit modes 64 through 72 (regular) and 80 through 91 (layered) and whose MLC locations are listed in the Extended MLC Records Table 726. Any MLC ID listed in the EFDM 736 will be in the extended MLC Records Table 726.

It is also possible to describe a PHY Type 1 mLC in the EFDM 736 and in the extended MLC Records Table 726. This is indicated in FIG. 7 using dotted lines to indicate that it is optional. Describing a PHY Type 1 mLC in the EFDM 736 and in the extended MLC Records Table 726 takes advantage of the higher peak rate available with a PHY type 2 transmit mode. Furthermore, such MLCs would use the same MAC trailer syntax as a PHY Type 2 MLCs to be able to carry the longer length fields as defined in the extended MLC records table 726.

In accordance with an embodiment of the system and method for the simultaneous transmission and reception of FLO and FLO-EV data, the Extended Flow Description Message 736 is readable only by a portable communication device 200 configured to receive FLO-EV data.

Control channel information for accessing the FLO data stream is placed in the FDM 734 and the control channel information for accessing the FLO-EV data stream is placed in the EFDM.

The control channel 730 also includes an Extended Neighbor Description Message (ENDM) 738. The ENDM 738 contains the exact frequency that corresponds to their RF_ID (radio frequency identifier) of the control channel, and all the MLCs contained within the FDM 734 and the EFDM 736. The ENDM is readable by both FLO and FLO-EV devices.

The locations of FLO and FLO-EV MLCs within the superframe can be placed in either the MLC Record Table 724, or in the extended MLC Records Table 726. A reason for segregating the MLCs in the SystemParameter message 722 with respect to the MLC Record Table 724 and the extended MLC Records Table 726 is that such separation aids transmission security and allows a clear design demarcation. The segregation scheme is done at the control channel level and thus a FLO device will never attempt to capture an MLC_IDs that carries FLO-EV data.

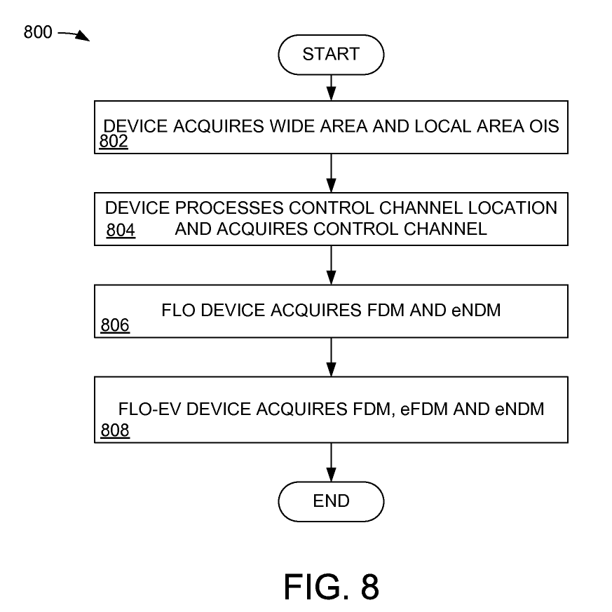

FIG. 8 is a flowchart describing an exemplary power up sequence of a portable communication device 200 of FIG. 1. In block 802 the portable communication device 200 acquires the wide-area OIS and the local area OIS in the superframe 300 (FIG. 3).

In block 804, the portable communication device 200 processes the control channel (CC) location and acquires the control channel. In block 806, a portable communication device 200 configured to receive FLO data acquires the flow description message (FDM) and the extended neighbor description message (ENDM). The FDM is associated with the PHY Type 1 mLC that carries the FLO data, while the ENDM is not associated with an MLC.

In block 808, a portable communication device 200 configured to receive FLO-EV data acquires the flow description message (FDM), the extended flow description message (EFDM) and the extended neighbor description message (ENDM). The FDM is associated with the PHY Type 1 MLCs that carry the FLO data and the EFDM is associated with the PHY Type 2 MLCs that carry the FLO-EV data. In an embodiment, the EFDM 736 will carry description information for PHY Type 1 MLCs that are described in the extended MLC records table 726 in the OIS, and that use a MAC trailer structure that is similar to that of PHY Type 2 MLCs with the purpose of carrying up to 8192 bits worth of data (instead of the maximum limit of 2048 bits for FLO MLCs).

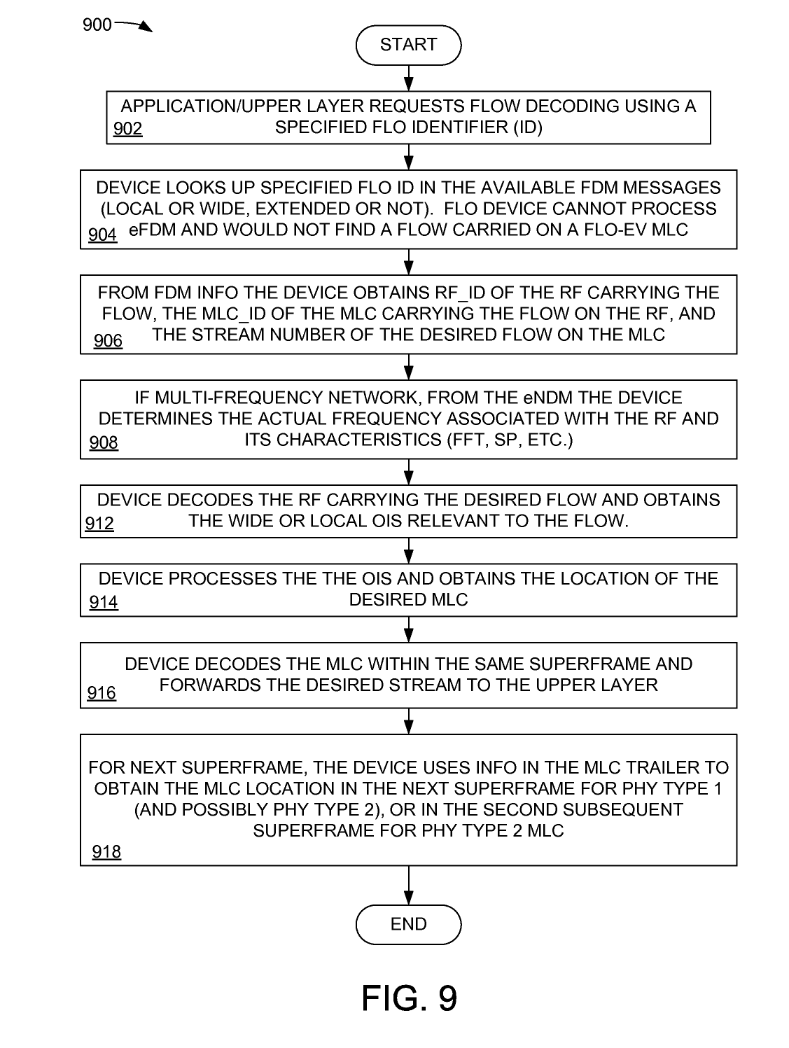

FIG. 9 is a flowchart describing flow acquisition in a portable communication device 200 of FIG. 1. In block 902, an application/upper layer (not shown for simplicity) requests flow decoding using a specified flow identifier (FLO_ID). The FLO_ID is provided in the FDM and in the EFDM (FIG. 7). Regarding backward compatibility, the portable communication device 200 will receive the SystemParameters message 500 and 505 (FIG. 5) and will use the MinProtocolVersion field 516 and the ProtocolVersion field 518 to determine whether it can decode the subject RF channel. If the MinProtocolVersion field 516 is set to 0, then FLO devices, that accept version 0 and 1, can decode this RF, and the CC is sent using a PHY Type 1 transmit mode. This implies a dependency between the CC transmit mode and backward compatibility. The dependency exists because, in an embodiment, a single CC is implemented. In an alternative embodiment in which a CC is sent using both a PHY type 1 transmit mode and a PHY Type 2 transmit mode, the second CC information is added at the end of the message similarly to the extended MLC location table. If backward compatibility is not desired, then the MinProtocolVersion field 516 and ProtocolVersion field 518 can be set to 2, and then the CC mode can be a PHY Type 2 transmit mode if desired.

In block 904, the portable communication device 200 looks up the specified FLO_ID in the available FDM 734 or EFDM 736 (local or wide). A portable communication device configured to process only FLO data can

ot process the EFDM 736 and would not find a flow carried on a FLO-EV MLC.

In block 906, from the FDM 734, the portable communication device 200 obtains the RF_ID of the radio frequency signal carrying the flow, the MLC ID of the MLC carrying the flow on the radio frequency signal, and the stream number of the desired flow on the MLC.

In block 908, if a multiple frequency network is implemented, from the extended neighbor description message 738, the portable communication device 200 determines the actual frequency associated with the RF and its radio characteristics.

In block 912, the portable communication device 200 decodes the radio frequency signal carrying the desired flow and obtains the wide or local OIS relevant to the particular flow.

In block 914, the portable communication device 200 processes the OIS and obtains the locations of the desired MLC.

In block 916, the portable communication device 200 decodes the MLC within the same superframe and forwards the desired stream to the application/upper layer.

In block 918, for the next superframe, the portable communication device 200 uses information in the MLC trailer to obtain the MLC location in the next superframe for a PHY Type 1 or PHY Type 2 MLCs with the trailer flag NextSuperframeOffsetFlag set to 0, or in the second subsequent superframe for a PHY Type 2 mLC with the trailer flag NextSuperframeOffsetFlag set to 1.

While various embodiments of the invention have been described, it will be apparent to those of ordinary skill in the art that many more embodiments and implementations are possible that are within the scope of the invention.

What is claimed is:

1. A system for receiving data, comprising:
a receiver configured to receive a radio frequency communication signal comprising at least one superframe, the at least one superframe having at least a first data stream encoded therein; and
overhead information carried in the superframe, the overhead information comprising a control channel, the control channel having control channel information for separating the at least one first data stream from any other data streams encoded in the at least one superframe.

2. The system of claim 1, wherein the control channel further comprises:
a flow description message (FDM) having an identifier that identifies attributes of the first data stream; and
an extended flow description message (EFDM) having an identifier that identifies attributes of a second data stream.

3. The system of claim 2, wherein the control channel further comprises:
a first control channel corresponding to the first data stream and a second control channel corresponding to the second data stream.

4. The system of claim 2, wherein the control channel further comprises:
a single control channel corresponding to the first data stream and the second data stream.

5. The system of claim 1, wherein the overhead information includes a minimum protocol version and a protocol version, where the minimum protocol version and the protocol version determine a dependency on which of a plurality of transmit modes can be used for the control channel information.

6. The system of claim 1, wherein the first data stream corresponds to a first set of transmit modes and the second data stream corresponds to a second set of transmit modes.

7. The system of claim 6, wherein the flow description message (FDM) corresponds to a multicast logical channel (MLC) records table and the extended flow description message (FDM) corresponds to an extended MLC records table, where the (MLC) records table and the extended MLC records table are separate thereby allowing the first data stream and the second data stream to be received independently.

8. The system of claim 7, wherein the receiver processes the first data stream while ignoring the second data stream.

9. The system of claim 7, wherein the receiver processes the first data stream and the second data stream.

10. The system of claim 7, wherein the receiver processes the second data stream while ignoring the first data stream.

11. The system of claim 7, wherein the first data stream and the second data stream are carried in the same superframe.

12. The system of claim 7, wherein only the first data stream is carried in the superframe.

13. The system of claim 7, wherein only the second data stream is carried in the superframe.

14. A method for receiving data, comprising:
receiving a radio frequency communication signal comprising at least one superframe, the at least one superframe having at least a first data stream encoded therein; and
decoding overhead information carried in the superframe, the overhead information comprising a control channel, the control channel having control channel information for separating the at least one first data stream from any other data streams encoded in the at least one superframe.

15. The method of claim 14, further comprising:
providing in the control channel a flow description message (FDM), the flow description message (FDM) having an identifier that identifies attributes of the first data stream; and
providing in the control channel an extended flow description message (EFDM), the extended flow description message (EFDM) having an identifier that identifies attributes of a second data stream.

16. The method of claim 15, further comprising:
providing in the overhead information a first control channel corresponding to the first data stream and a second control channel corresponding to the second data stream.

17. The method of claim 15, further comprising:
providing in the overhead information a single control channel corresponding to the first data stream and the second data stream.

18. The method of claim 14, further comprising providing in the overhead information a minimum protocol version and a protocol version, where the minimum protocol version and the protocol version determine a dependency on which of a plurality of transmit modes can be used for the control channel information.

19. The method of claim 14, wherein the first data stream corresponds to a first set of transmit modes and the second data stream corresponds to a second set of transmit modes.

20. The method of claim 19, wherein the flow description message (FDM) corresponds to a multicast logical channel (MLC) records table and the extended flow description message (FDM) corresponds to an extended MLC records table, where the (MLC) records table and the extended MLC records table are separate thereby allowing the first data stream and the second data stream to be received independently.

21. The method of claim 20, further comprising processing the first data stream while ignoring the second data stream.

22. The method of claim 20, further comprising processing the first data stream and the second data stream.

23. The method of claim 20, further comprising processing the second data stream while ignoring the first data stream.

24. The method of claim 20, further comprising carrying the first data stream and the second data stream in the same superframe.

25. The method of claim 20, further comprising carrying only the first data stream in the superframe.

26. The method of claim 20, further comprising carrying only the second data stream in the superframe.

27. A system for transmitting a data stream, comprising:
a transmitter for broadcasting a radio frequency communication signal comprising at least one superframe, the at least one superframe having at least a first data stream encoded therein; and
overhead information carried in the superframe, the overhead information comprising a control channel, the control channel having control channel information for separating the at least one first data stream from any other data streams encoded in the at least one superframe.

28. The system of claim 27, wherein the control channel further comprises:
a flow description message (FDM) having an identifier that identifies attributes of the first data stream; and
an extended flow description message (EFDM) having an identifier that identifies attributes of a second data stream.

29. The system of claim 28, wherein the control channel further comprises:
a first control channel corresponding to the first data stream and a second control channel corresponding to the second data stream.

30. The system of claim 28, wherein the control channel further comprises:
a single control channel corresponding to the first data stream and the second data stream.

31. The system of claim 27, wherein the overhead information includes a minimum protocol version and a protocol version located in a systems parameters message, where the minimum protocol version and the protocol version determines a dependency on which of a plurality of transmit modes can be used for the control channel information.

32. The system of claim 27, wherein the first data stream corresponds to a first set of transmit modes and the second data stream corresponds to a second set of transmit modes.

33. The system of claim 32, wherein the flow description message (FDM) corresponds to a multicast logical channel (MLC) records table and the extended flow description message (FDM) corresponds to an extended MLC records table, where the (MLC) records table and the extended MLC records table are separate thereby allowing the first data stream and the second data stream to be received independently.

34. The system of claim 33, wherein the first data stream and the second data stream are carried in the same superframe.

35. The system of claim 33, wherein only the first data stream is carried in a superframe.

36. The system of claim 33, wherein only the second data stream is carried in a superframe.

37. The system of claim 33, wherein at least one field in the extended MLC records table accommodates information in addition to a corresponding field in the MLC records table to allow transport of additional information.
